(19) United States
(12) Patent Application Publication
(10) Pub. No.: US 2014/0290458 A1
(43) Pub. Date: Oct. 2, 2014

(54) Device for Limiting the Length of a Cut

(71) Applicant: Robert Bosch GmbH, Stuttgart (DE)

(72) Inventors: Bruno Sinzig, Oberbipp (CH); Laurent Gribi, Buren an der Aare (CH)

(73) Assignee: Robert Bosch GmbH, Stuttgart (DE)

(21) Appl. No.: 14/357,067

(22) PCT Filed: Sep. 19, 2012
(86) PCT No.: PCT/EP2012/068338

§ 371 Date: May 8, 2014

(30) Foreign Application Priority Data
Nov. 15, 2011 (DE) 10 2011 086 334.6

(51) Int. Cl. B23Q 16/00

(52) U.S. Cl. CPC B23Q 16/001
USPC 83/477.2

(57) ABSTRACT

A device for limiting the length of a cut, to be used in portable machine tools, comprises at least one stop unit that has at least one stop element which can be fixed to a force-feed unit. At least one adjustment unit is provided to adjust a stop element position which corresponds to a desired length of a cut, in accordance with a cut depth that has been set.

### PRIOR ART

There are already known cut-length limiting devices for portable power tools, which comprise a stop unit having a stop element that can be fastened to a constraining guide unit.

### DISCLOSURE OF THE INVENTION

The invention is based on a cut-length limiting device for portable power tools, having at least one stop unit, which comprises at least one stop element that can be fastened to a constraining guide unit.

It is proposed that the cut-length limiting device comprise one setting unit, which is provided to set a position of the stop element that corresponds to a required length of cut, in dependence on a set depth of cut. A “cut-length limiting device” is to be understood here to mean, in particular, a device provided to limit a length of a cut to be made in a workpiece by means of a working tool coupled to a portable power tool, starting from a zero point, to a value required by an operator, in particular as viewed in a plane running at least substantially parallelwise in relation to a workpiece surface of a workpiece. The working tool is preferably realized as a circular saw blade. “Provided” is to be understood to mean, in particular, specially designed and/or specially equipped. “Substantially parallelwise” is intended here to mean, in particular, an alignment of a direction relative to a reference direction, in particular in one plane, wherein the direction deviates from the reference direction by, in particular, less than 8°, advantageously less than 5°, and particularly advantageously less than 2°.

Preferably, the stop unit of the cut-length limiting device is provided to define, by means of the stop element, an end point of a distance over which the portable power tool moves during a movement of the portable power tool relative to the constraining guide unit and/or relative to the workpiece, in particular during a sliding movement on a surface of the constraining guide unit and/or on a workpiece surface. The stop element in this case is preferably connected to a coupling element of the constraining guide unit by means of a form-closed and/or force-closed connection. A “constraining guide unit” is to be understood here to mean, in particular, a unit provided to guide the portable power tool along a predefined path during a movement in a plane, in particular while work is being performed on the workpiece, by means of at least one constraining force acting upon the portable power tool, transversely in relation to a direction of movement. The expression “constraining force” is to be understood here to mean, in particular, a force provided to prevent a body from moving in at least one direction and/or to keep the body, during a movement, on a path defined by action of the force upon the body. The constraining guide unit is preferably realized as a guide rail, which can be disposed on the workpiece. In this case, the coupling element of the constraining guide unit is preferably realized as a guide web. It is also conceivable, however, for the coupling element to be realized as a guide groove, in which, for example, a guide region of the stop element, realized as a guide web, can engage when coupled to the constraining guide unit.

Preferably, by means of the setting unit, it is possible to set an end point of a movement distance along which the portable power tool is moved, while work is being performed on the workpiece by means of the working tool, in particular while a cut is being made in the workpiece by means of the working tool, relative to the constraining guide unit and/or relative to the workpiece, in particular on a surface of the constraining guide unit and/or on a workpiece surface. Preferably, at least one characteristic quantity of a depth of cut, set by means of a cut-depth limiting device of the portable power tool, is taken into account in a setting of a position of the stop element by means of the setting unit. At least one dimension of the working tool that is dependent on a depth of cut, such as, in particular, a diameter of the working tool, is preferably taken into account. The design of the cut-length limiting device according to the invention makes it possible, advantageously, to adhere exactly to a length of cut, required by an operator, of a cut to be made in the workpiece by means of the working tool, in particular the circular saw blade. Advantageously, therefore, a change in a length of cut as a result of a change in a depth of cut of the working tool can be taken into account in a setting of a position of the stop element for the purpose of limiting a length of cut. In addition, advantageously, in particular if the cut-length limiting device is used in combination with a portable power tool realized as a plunge-cut circular saw, it is possible to achieve precise adherence to a length of cut required by an operator while work is being performed on the workpiece, dissociated from visual checking for the purpose of adhering to a required length of cut, since adherence to a required length of cut is indicated to an operator, advantageously, in that the latter is able to discern, by tactile and/or acoustic means, when the portable power tool, realized as a plunge-cut circular saw, strikes against the stop element.

Furthermore, it is proposed that the setting unit comprise at least one latching element, for fixing a position of a setting element of the setting unit relative to the stop element, in at least one operating state. Preferably, by means of the latching element, the setting element can be fixed in positions that correspond to a set depth of cut. Preferably, the setting element comprises at least one counter-latching region, which has a gradation corresponding to a gradation for setting a depth of cut by means of the cut-depth limiting unit. It is also conceivable, however, for the counter-latching region to constitute a possibility for steplessly fixing a position of the setting element. Thus, through simple design means, a set depth of cut can be compensated on the constraining guide unit in a setting of a position of the stop element relative to the constraining guide unit.

Advantageously, the setting unit comprises at least one setting element, which is disposed on a setting positioning element of the setting unit so as to be movable at least linearly relative to the stop element. Preferably, the setting element has a form closure region, which is provided to guide the setting element in a linear movement relative to the setting positioning element. The form closure region is preferably realized as a tongue and groove connection. The form closure region of the setting element, realized as a tongue, thus preferably engages in a guide region of the setting positioning element that is realized as a groove. It is also conceivable, however, for the form closure region of the setting element to be realized as a groove, in which the guide region of the setting positioning element, realized as a tongue, engages. Other designs of the form closure region and of the guide region, considered appropriate by persons skilled in the art, are likewise conceivable. The design of the setting unit according to the invention makes it possible, advantageously, to effect convenient setting of a position of the stop element in dependence on a set depth of cut. By means of a movement of the setting element relative to the stop element, a length of a cut to be made in the workpiece by means of the working tool, in particular the circular saw blade, said length being dependent on a depth of cut, can be taken into account, advantageously, for setting a position of the stop element that corresponds to a required length of cut.

Particularly preferably, the setting positioning element is mounted so as to be pivotable, at least relative to the stop element. The setting positioning element in this case is preferably pivotally mounted on the stop element. An operation of pivoting the setting positioning element thus renders the stop element advantageously accessible, in particular for the purpose of fastening the stop element to the constraining guide unit. Moreover, by means of a pivot movement of the setting positioning element relative to the stop element, the stop element can be positioned, advantageously, in dependence on a set depth of cut from at least two sides of the constraining guide unit.

It is additionally proposed that the cut-length limiting device have at least one clamping unit, which comprises at least one clamping element that is provided to fix the stop element to the constraining guide unit. Preferably, the clamping element is realized as clamping plate, which acts to generate a clamping force, by means of a clamping screw, upon a web-type coupling element of the constraining guide unit. The design of the cut-length limiting device makes it possible, advantageously, for the stop element to be securely fixed on the constraining guide unit, in a position relative to the constraining guide unit, by means of action of a clamping force.

Preferably, the clamping unit has at least one operating element for generating a clamping force for fixing the stop element to the constraining guide unit. The operating element is preferably realized as an operating lever. A clamping force, for fixing the stop element to the constraining guide unit, can thus be generated in a convenient manner, and in particular without the use of tools.

The invention is additionally based on a power tool guide system that comprises the cut-length limiting device according to the invention and the constraining guide unit. It is thus advantageously possible to achieve a system that can be used to conveniently set a length of cut in dependence on a set depth of cut, while work is being performed on a workpiece.

Preferably, the constraining guide unit has at least one coupling element, to which the stop element can be fastened by means of the clamping unit of the cut-length limiting device. The stop element of the stop unit of the cut-length limiting device preferably has a guide region, corresponding to the coupling element of the constraining guide unit, for connecting the stop element to the constraining guide unit in a form-closed manner. Through simple design means, a guide function and a fastening function can be achieved for the stop element, when coupled to the constraining guide unit.

The invention is additionally based on a power tool working system, having at least one portable power tool, in particular a circular saw, and having at least one power tool guide system according to the invention. A “portable power tool” is to be understood here to mean, in particular, a power tool, in particular a hand-held power tool, that can be transported by an operator without the use of a transport machine. The portable power tool has, in particular, a mass of less than 40 kg, preferably less than 10 kg, and particularly preferably less than 5 kg. Particularly preferably, the portable power tool is realized as plunge-cut circular saw. The portable power tool preferably has at least one cut-depth limiting unit, which is provided to set a depth of cut of the working tool that can be coupled to a tool receiver of the portable power tool. The expression “cut-depth limiting unit” is intended here to define, in particular, a unit provided to limit a distance to which the working tool, in particular a circular-saw blade, connected to the tool receiver of the portable power tool is inserted into a workpiece on which work is to be performed, and/or to set a length of the insertion distance. In this case, the distance to which the working tool is inserted in the workpiece on which work is to be performed is as viewed along a direction running at least substantially perpendicularly in relation to a seating face of a seating unit of the portable power tool, by which the portable power tool is seated on a workpiece surface of a workpiece on which work is to be performed. The expression “substantially perpendicularly” is intended here to define, in particular, an alignment of a direction relative to a reference direction, wherein the direction and the reference direction, in particular as viewed in one plane, enclose an angle of 90° and the angle has a maximum deviation of, in particular, less than 8°, advantageously less than 5°, and particularly advantageously less than 2°. The design of the power tool working system according to the invention makes it possible, advantageously, to perform work on a workpiece in a precise manner by means of the portable power tool. Moreover, advantageously, the design of the power tool working system according to the invention enables a high degree of operating convenience to be achieved during working on a workpiece.

The cut-length limiting device according to the invention, the power tool guide system according to the invention and/or the power tool working system according to the invention are/is not intended in this case to be limited to the application and embodiment described above. In particular, the cut-length limiting device according to the invention, the power tool guide system according to the invention and/or the power tool working system according to the invention may have individual elements, components and units that differ in number from a number stated herein, in order to fulfill a principle of function described herein.

### DRAWING

Further advantages are given by the following description of the drawing. The drawing shows an exemplary embodiment of the invention. The drawing, the description and the claims contain numerous features in combination. Persons skilled in the art will also expediently consider the features individually and combine them to create appropriate further combinations.

In the drawing:

FIG. 1 shows, in a schematic representation, a power tool working system according to the invention, with a portable power tool, and with a power tool guide system according to the invention, while work is performed on a workpiece,

FIG. 2 shows, in a schematic representation, a detail view of the power tool guide system according to the invention, with a cut-length limiting device according to the invention, and with a constraining guide unit,

FIG. 3 shows, in a schematic representation, an exploded view of the cut-length limiting device according to the invention,

FIG. 4 shows, in a schematic representation, a detail view of the portable power tool, with a depth of cut of a working tool that is coupled to the portable power tool, the depth of cut being limited by means of a cut-depth limiting device of the portable power tool, and

FIG. 5 shows, in a schematic representation, a detail view of the portable power tool, with a depth of cut of a working tool that is coupled to the portable power tool, the depth of cut being settable to a maximum by means of a cut-depth limiting device.

### DESCRIPTION OF THE EXEMPLARY EMBODIMENT

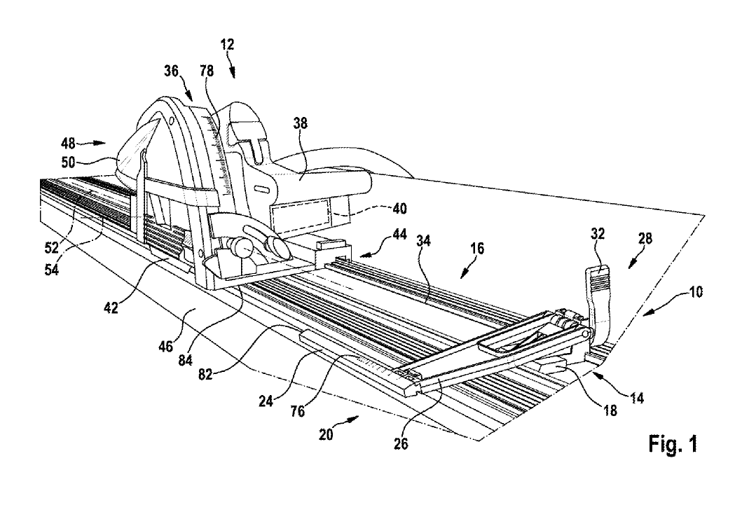

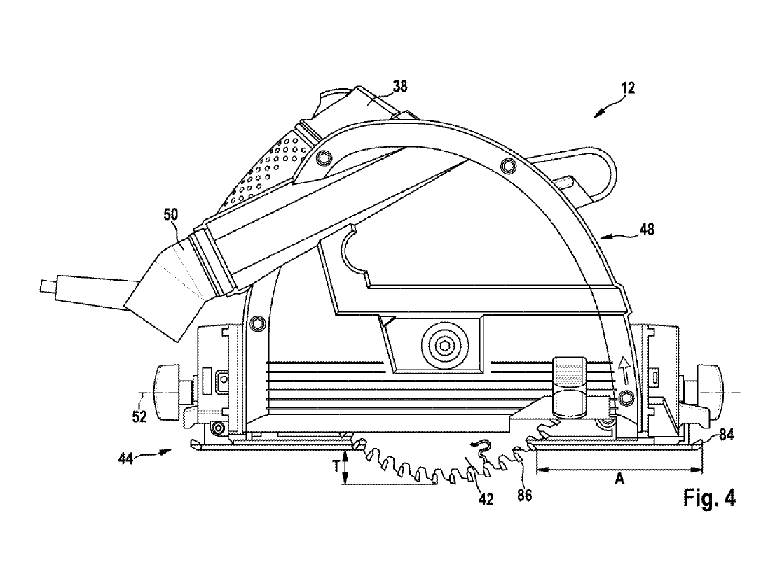

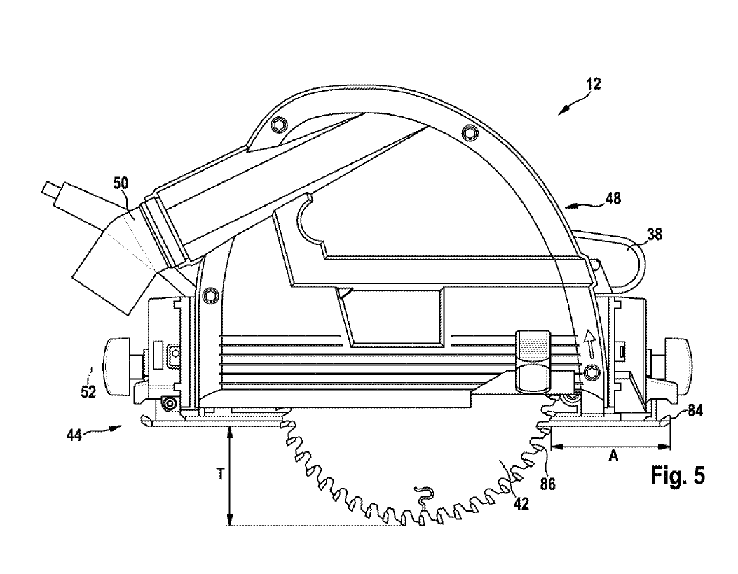

FIG. 1 shows a power tool working system, which comprises at least one portable power tool 12, realized as a plunge-cut circular saw, and at least one power tool guide system, which has a cut-length limiting device 10 and a constraining guide unit 16. The portable power tool 12, realized as a plunge-cut circular saw, comprises a cut-depth limiting unit 36, which is provided to set a depth of cut of a working tool 42 (FIGS. 4 and 5) that can be coupled to a tool receiver (not represented in greater detail here) of the portable power tool 12. A depth of cut T of the working tool 42 can be set, in a manner already known to persons skilled in the art, by means of a setting of a position of a limiting element (not represented in greater detail here). The portable power tool 12 additionally comprises a power tool housing 38, which is provided to enclose a drive unit 40 of the portable power tool 12. The drive unit 40 comprises a drive shaft (not represented in greater detail here) for driving the working tool 42, which can be coupled to the tool receiver (not represented in greater detail here), in a manner already known to persons skilled in the art. The portable power tool 12 additionally comprises a seating unit 44, realized as a base plate or slide pad, by means of which the portable power tool 12, when performing work on a workpiece 46, is seated on a workpiece surface of the workpiece 46, or on a surface of the constraining guide unit 16, or slides on the workpiece surface or on the surface of the constraining guide unit 16 during a movement for making a cut in the workpiece 46. The seating unit 44 in this case can be coupled to the constraining guide unit 16 in a manner already known to persons skilled in the art. Additionally disposed on the seating unit 44 is a safety unit 48 of the portable power tool 12, which protects an operator against injury when performing work on the workpiece 46. In this case, the safety unit 48 is realized as a safety hood, which surrounds the working tool 42, when mounted, by more than 160° along a rotational direction of the drive shaft. The safety unit 48 additionally has a suction coupling element 50, which can be connected to a suction unit (not represented in greater detail here) for extracting removed workpiece particles by suction as work is being performed on the workpiece 46. The power tool housing is mounted on the safety unit 48 so as to be pivotable relative to the seating unit 44. In this case, the power tool housing 38 is mounted on the safety unit 48 so as to be pivotable about two pivot axes 52, 54, relative to the seating unit 44, in a manner already known to persons skilled in the art. The two pivot axes 52, 54 extend at least substantially perpendicularly relative to each other. In this case, the safety unit 48, together with the power tool housing 38, is mounted on the seating unit 44 so as to be pivotable about the pivot axis 52, relative to the seating unit 44. Moreover, the cut-depth limiting unit is disposed on a side of the safety unit 48 that faces toward the power tool housing 38. The portable power tool 12 is thus of a design that is at least substantially already known to persons skilled in the art.

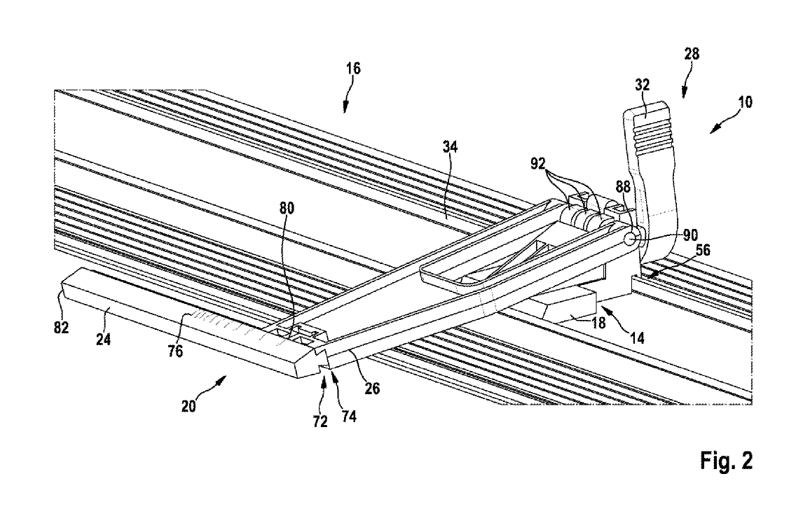

FIG. 2 shows the power tool guide system, having at least the cut-length limiting device 10 and having at least the constraining guide unit 16. The constraining guide unit 16 is realized as a guide rail. The cut length limiting device 10 for the portable power tool 12 has at least one stop unit 14, which comprises at least one stop element 18 that can be fastened to the constraining guide unit 16. The stop element 18 has a guide region 56, for fastening to the constraining guide unit 16. The guide region 56 in this case is constituted by a groove. The constraining guide unit comprises a coupling element 34, for acting in combination with the guide region 56 realized as a groove. The coupling element 34 is realized as a web, which, when the constraining guide unit 16 has been placed on the workpiece 46, extends on a side of the constraining guide unit 16 that faces away from the workpiece 46, at least substantially perpendicularly in a direction away from the constraining guide unit 16. The coupling element 34 has an at least substantially polygonal cross section, which is designed to correspond with the guide region 56 realized as a groove. When the stop element 18 has been mounted on the constraining guide unit 16, the coupling element 34 engages in the guide region 56 realized as a groove, for the purpose of guiding the stop element 18.

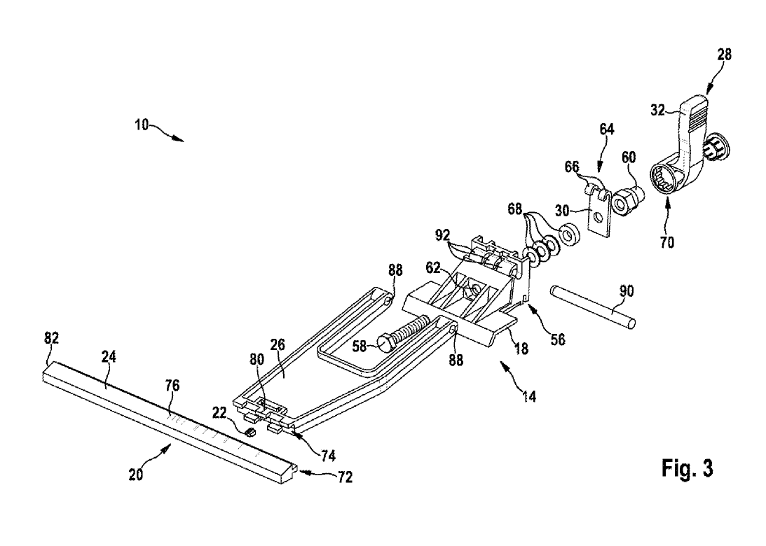

For the purpose of fixing the stop element 18, the cut-length limiting device 10 comprises at least one clamping unit 28, which has at least one clamping element 30, which is provided to fix the stop element to the constraining guide unit 16. The clamping element 30 in this case is realized as a clamping plate (FIG. 3). The clamping element 30, realized as a clamping plate, is disposed on the stop element 18, such that it can be clamped by means of a clamping screw 58 and a clamping nut 60 of the clamping unit 28. The stop element 18 has a clamping screw receiver 62, in which the clamping screw 58 can be disposed in a rotationally fixed manner. An inner contour of the clamping screw receiver 62 is realized so as to correspond with a screw head of the clamping screw 58. The clamping nut 60 can be screwed on to a thread of the clamping screw 58, on a side of the clamping screw 58 that faces away from the screw head of the clamping screw 58. Moreover, the clamping element 30, realized as a clamping plate, is likewise disposed on the side of the clamping screw 58 that faces away from the screw head of the clamping screw 58. The clamping element 30 has a coupling region 64, which is provided for disposing the clamping element 30 in a pivotable manner on the stop element 18. The coupling region 64 has two hook-shaped extensions 66, which can be coupled to a receiving region of the stop element 18. When in a mounted state, the clamping element 30 is disposed between the stop element 18, spacer washers 68 of the clamping unit 28 and the clamping nut 60, as viewed along the screw axis of the clamping screw 58, wherein the coupling region 64 of the clamping element 30 is connected to the receiving region of the stop element 18. The clamping unit 28 has at least one operating element 32, for the purpose of generating a clamping force for fixing the stop element 18 to the constraining guide unit 16. The operating element 32 is realized as an operating lever. The operating element 32 in this case has a rotary driving region 70, which is provided to encompass the clamping nut 60 in a form-closed manner for the purpose of transmitting a torque, when in a mounted state.

The constraining guide unit 16 has at least the coupling element 34, to which the stop element 18 can be fastened by means of a clamping unit 28 of the cut-length limiting device 10. In this case, the guide region 56 of the stop element 18 and the coupling element 34 of the constraining guide unit 16 are connected to each other in a form-closed manner. An actuation of the operating element 32 then causes a clamping force to be generated, for the purpose of fixing the stop element 18 to the coupling element 34, relative to the constraining guide unit 16. As a result of a combined action of the clamping element 30 and the guide region 56, the coupling element 34 is thus, by means of a clamping force, clamped in between the clamping element 30 and an edge region of the stop element 18 that delimits the guide region 56. As a result of this, the stop element 18 is fixed to the coupling element 34, for the purpose of forming a stop to limit a length of cut required by an operator, during a movement of the portable power tool 12 on the constraining guide unit 16.

Furthermore, the cut-length limiting device 10 comprises at least one setting unit 20, which is provided to set a position of the stop element 18 that corresponds to a required length of cut, in dependence on a set depth of cut T. The setting unit 20 comprises at least one setting element 24, which is disposed on a setting positioning element 26 of the setting unit 20 so as to be movable at least linearly relative to the stop element 18. The setting element 24 in this case has a form closure region 72, which is provided to guide the setting element 24 in a linear movement relative to the setting positioning element 26. The form closure region 72 is realized as a tongue and groove connection. The form closure region 72 of the setting element 24, realized as a tongue, thus engages in a guide region 74 of the setting positioning element that is realized as a groove. The setting positioning element 26 is mounted so as to be pivotable, at least relative to the stop element 18. The setting positioning element 26 in this case has bearing recesses 88, in which a bearing pin 90 of the setting unit 20 engages. For the purpose of receiving the bearing pin 90, the stop element 18 comprises bearing elements 92, which are provided to receive the bearing pin 90 when in a mounted state. The setting positioning element 26 is thus pivotally mounted on the stop element 18.

In addition, the setting element 24 has a measurement scale 76, which is realized in dependence on a measurement scale 78 of the cut-depth limiting unit 36. For the purpose of setting a position of the setting element 24 relative to the stop element 18, the setting element 24 is moved linearly relative to the stop element 18 and linearly relative to the setting positioning element 26, until a position of the measurement scale 76 of the setting element 24 corresponds to a depth of cut T of the working tool 42 set by means of the measurement scale 78 of the cut-depth limiting unit 36. The setting positioning element 26 has an indicating element 80, for reading off the measurement scale 76 of the setting element 24. The setting unit 20 has at least one latching element 22, for the purpose of fixing a position of the setting element 24 of the setting unit 20 relative to the setting positioning element 26 and/or relative to the stop element 18. Thus, after a movement of the setting element 24 relative to the stop element 18 and relative to the setting positioning element 26, the setting element 24 can be fixed relative to the setting positioning element 26. The setting element 24 is provided to take account of, or compensate, a distance A, dependent on a depth of cut T of the working tool 42, from an outside edge 84 of the seating unit 44 to a cutting edge 86 of the working tool 42 that is usable during working on the workpiece 46, in a setting of a position of the stop element 18 on the constraining guide unit 16 that corresponds to a required length of cut (FIGS. 4 and 5).

To perform work on the workpiece 46 by means of the power tool working system, a depth of cut T of the working tool 42 is first set by means of the cut-depth limiting unit 36. The set depth of cut T can be read off using the measurement scale 78 of the cut-depth limiting unit 36. On the basis of the depth of cut T read off from the measurement scale 78 of the cut-depth limiting unit 36, the setting element 24 is moved linearly relative to the stop element 18 and linearly relative to the setting positioning element 26, until the indicating element 80 of the setting positioning element 26 indicates, on the measurement scale 76 of the setting element 24, a value read off from the measurement scale 78 of the cut-depth limiting unit 36. The setting element 24 is thereupon fixed in a position relative to the setting positioning element 26, by means of the latching element 22 of the setting unit 20. The stop element 18 is coupled to the constraining guide unit 16, which is already disposed on the workpiece 46. The stop element 18 is shifted along the coupling element 34 until a lateral edge 82 of the setting element 24 that faces away from the stop element 18 is flush with a marking (not represented in greater detail here) made on the workpiece 46, which marking is provided to indicate an end of a required cut, in a manner known to persons skilled in the art. It is also conceivable, however, if the stop element 18 is disposed on the coupling element 34, for the lateral edge 82 of the setting element 24 to be already flush with the marking. Once the lateral edge 82 of the setting element 24 is flush with the marking, the stop element 18 is fixed to the constraining guide unit 16 by means of the clamping unit 28. Since it is pivotally mounted on the stop element 18, the setting positioning element 26 can be pivoted away, to enable precise striking of the outer edge 84 of the seating unit 44.

FIGS. 4 and 5 show a dependence of the depth of cut T in relation to the distance A from the outer edge 84 of the seating unit 44 to the cutting edge 86 of the working tool 42 that is usable during working on the workpiece 46. The distance A is thus dependent on the extent to which the working tool 42 can be inserted into the workpiece 46 for the purpose of making a cut during working on the workpiece 46. In FIG. 5, a value of the distance A is less than a value of the distance A in FIG. 4. The length of cut that can be set by means of a position of the stop element 18 is thus also dependent on the change in the distance A, or on the change in the depth of cut T. A distance of the lateral edge 82 of the setting element 24 relative to the stop element 18 corresponds, in dependence on a set position of the setting element 24 relative to the setting positioning element 26, and thus relative to the stop element 18, to the distance A, dependent on a set depth of cut T, from the outer edge 84 of the seating unit 44 to the cutting edge 86 of the working tool 42 that is usable during working on the workpiece 46.

1. A cut-length limiting device for portable power tools, comprising:
at least one stop unit including at least one stop element configured to be fastened to a constraining guide unit; and
at least one setting unit configured to set a position of the at least one stop element corresponding to a required length of cut, in dependence on a set depth of cut.

2. The cut-length limiting device as claimed in claim 1, wherein the at least one setting unit includes at least one latching element configured to fix a position of a setting element of the at least one setting unit relative to the at least one stop element, in at least one operating state.

3. The cut-length limiting device as claimed in claim 1, wherein the at least one setting unit includes at least one setting element is disposed on a setting positioning element of the at least one setting unit so as to be movable at least linearly relative to the at least one stop element.

4. The cut-length limiting device as claimed in claim 3, wherein the setting positioning element is mounted so as to be pivotable, at least relative to the at least one stop element.

5. The cut-length limiting device as claimed in claim 1, further comprising:
at least one clamping unit including at least one clamping element configured to fix the at least one stop element to the constraining guide unit.

6. The cut-length limiting device as claimed in claim 5, wherein the clamping unit has at least one operating element configured to generate a clamping force to fix the at least one stop element to the constraining guide unit.

7. A power tool guide system, comprising:
at least one constraining guide unit; and
at least one cut-length limiting device including (i) at least one stop unit having at least one stop element configured to be fastened to the at least one constraining guide unit, and (ii) at least one setting unit configured to set a position of the at least one stop element corresponding to a required length of cut, in dependence on a set depth of cut.

8. The power tool guide system as claimed in claim 7, wherein:
the at least one cut-length limiting device includes a clamping unit; and
the at least one constraining guide unit includes at least one coupling element, to which the at least one stop element can is configured to be fastened by the clamping unit of the at least one cut-length limiting device.

9. A power tool working system, comprising:
at least one portable power tool; and
at least one power tool guide system 8 including at least one constraining guide unit and at least one cut-length limiting device,
wherein the at least one cut-length limiting device includes (i) at least one stop unit having at least one stop element configured to be fastened to the at least one constraining guide unit, and (ii) at least one setting unit configured to set a position of the at least one stop element corresponding to a required length of cut, in dependence on a set depth of cut.

10. The power tool working system of claim 9, wherein the at least one portable power tool includes a circular saw.
